(19) United States
(12) Patent Application Publication
(10) Pub. No.: US 2010/0159281 A1
(43) Pub. Date: Jun. 24, 2010

(54) MAGNETIC RECORDING MEDIUM MANUFACTURING METHOD

(75) Inventors: Seiji Morita, Yokohama-shi (JP); Kazuyo Umezawa, Yokohama-shi (JP); Shinobu Sugimura, Yokohama-shi (JP); Masatoshi Sakurai, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/643,811

(22) Filed: Dec. 21, 2009

(30) Foreign Application Priority Data
Dec. 22, 2008 (JP) 2008-326225

(51) Int. Cl. G11B 5/33; C08F 10/14; C08L 67/07

(52) U.S. Cl. 428/800; 216/22; 526/282; 525/170

(57) ABSTRACT

According to one embodiment, an ultraviolet-curable resin material to be used contains a monomer represented by formula (1) presented earlier, a resin stamper is used as a stamper, and the surface of a magnetic recording layer and the three-dimensional pattern surface of the resin stamper are contacted in a vacuum.

### CROSS-REFERENCE TO RELATED APPLICATIONS

This application is based upon and claims the benefit of priority from Japanese Patent Application No. 2008-326225, filed Dec. 22, 2008, the entire contents of which are incorporated herein by reference.

### BACKGROUND

1. Field

One embodiment of the present invention relates to a method of manufacturing a magnetic recording medium having discrete tracks on the surface of a magnetic recording layer.

2. Description of the Related Art

Recently, as described in, e.g., Jpn. Pat. Appln. KOKAI Publication No. 2004-110896, a discrete track medium that reduces magnetic interference between adjacent recording tracks by separating them by grooves or guard bands of a nonmagnetic material is attracting attention as a magnetic recording medium capable of further increasing the density. When manufacturing this discrete track medium, patterns of a magnetic layer can be formed by imprinting by using stamper. When those patterns of the magnetic layer, which correspond to signals in a servo area are formed together with the recording track patterns by imprinting, the cost can be reduced because a servo track writing step can be eliminated.

Conventionally, the discrete track medium is manufactured by transferring resist patterns from an Ni stamper by high-pressure imprinting or thermal imprinting. However, these conventional techniques are unsuitable for mass-production because the life of the Ni stamper is short. Also, if the data density is increased and tracks are made finer, resist patterns cannot be well transferred.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A to 1D are views for explaining a pattern transfer method for use in the present invention;

FIG. 2 is a view showing a magnetic recording/reproduction apparatus; and

FIG. 3 is a view for explaining a method of a magnetic disk according to the present invention.

### DETAILED DESCRIPTION

Various embodiments according to the invention will be described hereinafter with reference to the accompanying drawings. In general, according to one embodiment of a magnetic recording medium manufacturing method of the present invention, a magnetic recording medium and resin stamper are prepared. The magnetic recording medium includes a substrate and a magnetic recording layer formed on at least one major surface of the substrate and including a data area and servo area. The resin stamper has three-dimensional patterns duplicated from a metal stamper by injection molding.

Then, an uncured ultraviolet-curable resin layer containing a monomer represented by formula (1) presented earlier as a main component is formed on the magnetic recording layer.

Subsequently, the surface of the magnetic recording layer and the three-dimensional pattern surface of the stamper are engaged via the uncured ultraviolet-curable resin layer in a vacuum.

After that, the uncured ultraviolet-curable resin layer is cured as it is irradiated with ultraviolet light, and the resin stamper is separated, thereby forming, on one surface of the magnetic recording medium, an ultraviolet-curable resin layer onto which the three-dimensional patterns are transferred.

In addition, the ultraviolet-curable resin layer is used as a mask to perform dry etching, thereby forming three-dimensional patterns on the surface of the magnetic recording layer.

The present invention facilitates bonding and separation, and protects the stamper and transferred patterns from being easily damaged. Accordingly, it is possible to prolong the stamper life without increasing the cost, shorten the pattern transfer time, and form fine patterns. This makes it possible to reduce the manufacturing cost of a magnetic recording medium having discrete tracks, and increase the density of data.

The magnetic recording medium manufacturing method of the present invention is characterized in that the ultraviolet-curable resin material to be used contains a monomer represented by formula (1), a resin stamper is used as the stamper, and the surface of a magnetic recording layer and the three-dimensional pattern surface of the resin stamper are contacted in a vacuum.

The ultraviolet-curable resin usable in the present invention can contain a monomer, oligomer, and polymerization initiator.

An isobornyl acrylate (IBOA) monomer represented by formula (1) can be contained as a main component, and can also be used together with another monomer as needed. A “main component” herein mentioned is an element or a group of elements having a highest component ratio among components forming the material.

The following materials are used as the monomer material.

Acrylates

Bisphenol A•ethylene oxide modified diacrylate (BPEDA)

Dipentaerythritol hexa(penta)acrylate (DPEHA)

Dipentaerythritol monohydroxy pentaacrylate (DPEHPA)

Dipropyleneglycol diacrylate (DPGDA)

Ethoxylated trimethylolpropane triacrylate (ETMPTA)

Glycerinpropoxy triacrylate (GPTA)

4-Hydroxybutyl acrylate (HBA)

1,6-Hexanediol diacrylate (HDDA)

2-Hydroxyethyl acrylate (HEA)

2-Hydroxypropyl acrylate (HPA)

Isobornyl acrylate (IBOA)

Polyethyleneglycol diacrylate (PEDA)

Pentaerythritol triacrylate (PETA)

Tetrahydrofulfuryl acrylate (THFA)

Trimethylolpropane triacrylate (TMPTA)

Tripropyleneglycol diacrylate (TPGDA)

•Methacrylates

Tetraethyleneglycol dimethacrylate (4EDMA)

Alkyl methacrylate (AKMA)

Allyl methacrylate (AMA)

1,3-Buthyleneglycol dimethacrylate (BDMA)

n-butyl methacrylate (BMA)

Benzyl methacrylate (BZMA)

Cyclohexyl methacrylate (CHMA)

Diethyleneglycol dimethacrylate (DEGDMA)

2-Ethylhexyl methacrylate (EHMA)

Glycidyl methacrylate (GMA)

1,6-Hexanediol dimethacrylate (HDDMA)

2-Hydroxyethyl methacrylate (2-HEMA)

Isobornyl methacrylate (IBMA)

Lauryl methacrylate (LMA)

Phenoxyethyl methacrylate (PEMA)

t-Butyl methacrylate (TBMA)

Tetrahydrofulfuryl methacrylate (THFMA)

Trimethylolpropane trimethacrylate (TMPMA)

Similar to isobornyl acrylate (IBOA), tripropyleneglycol diacrylate (TPGDA), 1,6-hexanediol diacrylate (HDDA), dipropyleneglycol diacrylate (DPGDA), neopentylglycol diacrylate (NPDA), and ethoxylated isocyanuric acid triacrylate (TITA) are particularly favorable because they can decrease the viscosity to 10 CP or less.

As the oligomer material, it is possible to use, e.g., a urethane acrylate-based material, polyurethane diacrylate (PUDA), polyurethane hexaacrylate (PUHA), or urethane acrylate represented by formula (2) below.

According to an aspect of the present invention, urethane acrylate represented by formula (2) can be used.

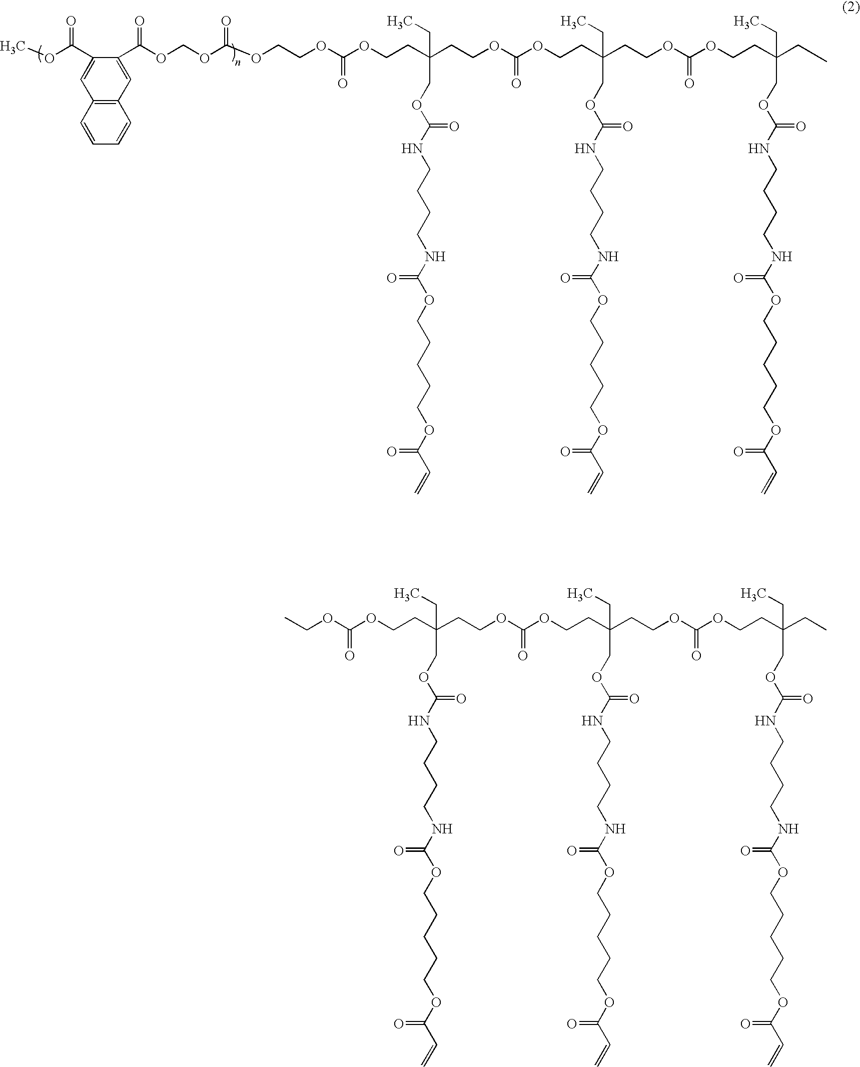

wherein n=25.

It is also possible to use polymethyl methacrylate (PMMA), polymethyl methacrylate fluoride (PMA-F), polycarbonate diacrylate, or polycarbonate methylmethacrylate fluoride (PMMA-PC-F).

The ultraviolet-curable resin layer can be formed by using an ultraviolet-curable resin material containing 80 to 90 wt % of an isobornyl acrylate monomer represented by formula (1) and an oligomer having a molecular weight larger than 2,500.

If the amount of isobornyl acrylate monomer is less than 80 wt %, adhesion to the surface layer of the magnetic recording medium worsens, and this increases the amount of ultraviolet-curable resin layer sticking to the resin stamper after it is separated. Also, the rotation time of spin coating prolongs in order to form a thin film, and this decreases the productivity. In addition, the ultraviolet radiation time for curing prolongs, and the groove width increases during dry etching because the dry etching resistance decreases. If the amount of isobornyl acrylate monomer is larger than 90 wt %, adhesion to the surface layer of the magnetic recording medium worsens, and this allows easy adhesion to the resin stamper after it is separated, thereby destroying the resin stamper surface. Additionally, the organic solvent resistance and water resistance decrease because the hardness decreases after curing, and the amount of etching residue increases when performing dry etching by using gaseous oxygen.

Also, if the molecular weight of the oligomer is 2,500 or less, the flexibility of the cured ultraviolet-curable resin decreases, adhesion to the resin stamper increases, and the surface roughens during dry etching because the dry etching resistance decreases.

The viscosity of the uncured ultraviolet-curable resin can be 10 centipoise (CP) or less at 25° C.

If the viscosity exceeds 10 CP, no thin film can be formed any longer, the difference between the film thickness in the inner periphery and that in the outer periphery increases during spin coating, the film thickness variation increases, patterns are formed on the surface after the resin stamper is separated, and the resin stamper readily deforms during vacuum contacting.

As the polymerization initiator, it is possible to use, e.g., Irgacure 184 or Darocure 1173 manufactured by Ciba-Geigy.

As the stamper resin material for use in the present invention, it is possible to use, e.g., a cyclic olefin polymer such as Zeonor 1060R manufactured by Zeon, or polycarbonate such as AD5503 manufactured by Teijin Chemicals. When using these resins, a transparent resin stamper having high ultraviolet transmittance can be formed.

Also, the resin stamper for use in the present invention can be formed as follows. For example, patterns are recorded on a first master having an electron beam resist by an electron beam recording apparatus, a first metal stamper is duplicated from the first master by electroforming, and a second metal stamper is duplicated from the first metal stamper by electroforming. After that, the resin stamper can be duplicated from the second metal stamper or a (2+N)th (N is a natural number) metal stamper by injection molding.

Furthermore, in the present invention, pattern transfer is performed by contacting the stamper to the uncured ultraviolet-curable resin layer in a vacuum.

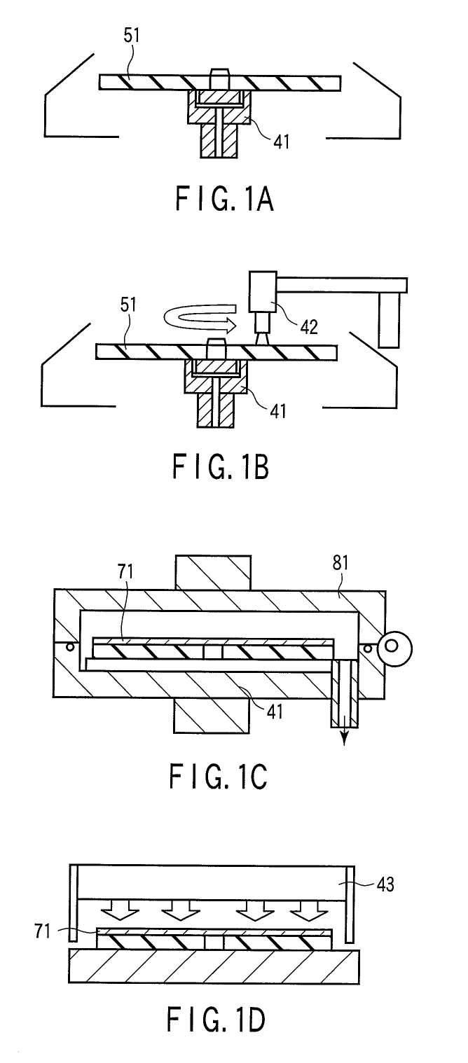

An outline of the pattern transfer method used in the present invention will be explained below with reference to FIGS. 1A to 1D.

FIGS. 1A to 1D illustrate a method of transferring patterns onto one surface of a medium substrate. As shown in FIG. 1A, a medium substrate 51 is set on a spinner 41. As shown in FIG. 1B, while the medium substrate 51 is spun together with the spinner 41, an ultraviolet-curable resin (2P resin) is dropped from a dispenser 42 and spread by spin coating. As shown in FIG. 1C, in a vacuum chamber 81, one surface of the magnetic recording medium 51 and the pattern surface of a transparent stamper 71 are engaged via a 2P resin layer (not shown) in a vacuum. As shown in FIG. 1D, the 2P resin layer is cured by emitting UV from a UV light source 43 through the transparent stamper 71 at the atmospheric pressure. After that, the transparent stamper 71 is separated.

Examples of the magnetic disk substrate usable in the present invention are a glass substrate, an Al-based alloy substrate, a ceramic substrate, a carbon substrate, an Si single-crystal substrate having an oxidized surface, and a substrate obtained by forming an NiP layer on the surface of any of these substrates. As the glass substrate, amorphous glass or crystallized glass can be used. Examples of the amorphous glass are soda lime glass and aluminosilicate glass. An example of the crystallized glass is lithium-based crystallized glass. As the ceramic substrate, it is possible to use a sintered product mainly containing aluminum oxide, aluminum nitride, or silicon nitride, or a material formed by fiber-reinforcing the sintered product. Plating or sputtering is used to form the NiP layer on the substrate surface.

When manufacturing a perpendicular magnetic recording medium, a so-called perpendicular double-layered medium can be formed by forming a perpendicular magnetic recording layer on a soft magnetic underlying layer (SUL) on a substrate. The soft magnetic underlying layer of the perpendicular double-layered medium passes a recording magnetic field from a recording magnetic pole, and returns the recording magnetic field to a return yoke placed near the recording magnetic pole. That is, the soft magnetic underlying layer performs a part of the function of a recording head. The soft magnetic underlying layer applies a steep perpendicular magnetic field to the recording layer, and increases the recording efficiency.

An example of the soft magnetic underlying layer usable in the present invention is a high-k material containing at least one of Fe, Ni, and Co. Examples of the material are FeCo-based alloys such as FeCo and FeCoV, FeNi-based alloys such as FeNi, FeNiMo, FeNiCr, and FeNiSi, FeAl-based and FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN.

As the soft magnetic underlying layer, it is also possible to use a material having a microcrystal structure such as FeAlO, FeMgO, FeTaN, or FeZrN containing 60 at % or more of Fe, or a granular structure in which fine crystal grains are dispersed in a matrix.

As another material of the soft magnetic underlying layer, it is possible to use a Co alloy containing Co and at least one of Zr, Hf, Nb, Ta, Ti, and Y. The content of Co can be 80 at or more. An amorphous layer is readily formed when a film of the Co alloy is formed by sputtering. The amorphous soft magnetic material has none of magnetocrystalline anisotropy, a crystal defect, and a grain boundary, and hence has superb soft magnetism. It is also possible to reduce the noise of the medium by using the amorphous soft magnetic material. Favorable examples of the amorphous soft magnetic material are CoZr-based, CoZrNb-based, and CoZrTa-based alloys.

Another underlying layer may also be formed below the soft magnetic underlying layer in order to improve the crystallinity of the soft magnetic underlying layer or improve the adhesion to the substrate. As the underlying layer material, it is possible to use Ti, Ta, W, Cr, Pt, an alloy containing any of these materials, or an oxide or nitride of any of these materials.

An interlayer of a nonmagnetic material can be formed between the soft magnetic underlying layer and perpendicular magnetic recording layer. The interlayer interrupts the exchange coupling interaction between the soft magnetic underlying layer and recording layer, and controls the crystallinity of the recording layer. As the interlayer material, it is possible to use Ru, Pt, Pd, W, Ti, Ta, Cr, Si, an alloy containing any of these materials, or an oxide or nitride of any of these materials.

To prevent spike noise, it is possible to divide the soft magnetic underlying layer into a plurality of layers, and antiferromagnetically couple these layers with 0.5- to 1.5-nm-thick Ru films sandwiched between them. Also, the soft magnetic layer can be coupled by exchange coupling with a hard magnetic film having in-plane anisotropy such as CoCrPt, SmCo, or FePt, or a pinning layer of an antiferromagnetic material such as IrMn or PtMn. To control the exchange coupling force, a magnetic layer such as a Co layer or a nonmagnetic layer such as Pt layer can be stacked above and below the Ru layer.

As the perpendicular magnetic recording layer usable in the present invention, it is possible to use a material mainly containing Co, containing at least Pt, containing Cr as needed, and further containing an oxide (e.g., silicon oxide or titanium oxide). In this perpendicular magnetic recording layer, the magnetic crystal grains can form a columnar structure. In the perpendicular magnetic recording layer having this structure, the orientation and crystallinity of the magnetic crystal grains are favorable. As a consequence, a signal-to-noise ratio (SNR) suitable for high-density recording can be obtained. The amount of oxide is important to obtain the above structure. The content of oxide can be 3 to 12 mol %, and can also be 5 to 10 mol %, with respect to the total amount of Co, Pt, and Cr. When the content of oxide in the perpendicular magnetic recording layer falls within the above range, the oxide deposits around the magnetic grains, so the magnetic grains can be isolated and reduced in size. If the content of oxide exceeds the above range, the oxide remains in the magnetic grains and deteriorates the orientation and crystallinity of the magnetic grains. Furthermore, the oxide deposits above and below the magnetic grains. Consequently, the magnetic grains often do not form the columnar structure vertically extending through the perpendicular magnetic recording layer. On the other hand, if the content of oxide is less than the above range, the magnetic grains are insufficiently isolated and reduced in size. As a consequence, noise increases in recording and reproduction, and this often makes it impossible to obtain a signal-to-noise ratio (SNR) suited to high-density recording.

The content of Pt in the perpendicular magnetic recording layer can be 10 to 25 at %. When the Pt content falls within the above range, a uniaxial magnetic anisotropy constant Ku necessary for the perpendicular magnetic recording layer is obtained. In addition, the crystallinity and orientation of the magnetic grains improve. Consequently, a thermal decay characteristic and recording/reproduction characteristic suited to high-density recording are obtained. If the Pt content exceeds the above range, a layer having the fcc structure is formed in the magnetic grains, and the crystallinity and orientation may deteriorate. On the other hand, if the Pt content is less than the above range, it is often impossible to obtain Ku, i.e., a thermal decay characteristic suitable for high-density recording.

The Content of Cr in the perpendicular magnetic recording layer can be 0 to 16 at %, and can also be 10 to 14 at %. When the Cr content falls within the above range, it is possible to maintain high magnetization without decreasing the uniaxial magnetic anisotropy constant Ku of the magnetic grains. Consequently, a recording/reproduction characteristic suited to high-density recording and a sufficient thermal decay characteristic are obtained. If the Cr content exceeds the above range, the thermal decay characteristic worsens because Ku of the magnetic grains decreases. In addition, the crystallinity and orientation of the magnetic grains worsen. As a consequence, the recording/reproduction characteristic tends to worsen.

The perpendicular magnetic recording layer can contain at least one type of an additive element selected from B, Ta, Mo, Cu, Nd, W, Nb, Sm, Tb, Ru, and Re, in addition to Co, Pt, Cr, and an oxide. These additive elements can promote the size reduction of the magnetic grains, or improve the crystallinity and orientation of the magnetic grains. This makes it possible to obtain a recording/reproduction characteristic and thermal decay characteristic more suitable for high-density recording. The total content of these additive elements can be 8 at % or less. If the total content exceeds 8 at %, a phase other than the hcp phase is formed in the magnetic grains, and this disturbs the crystallinity and orientation of the magnetic grains. As a result, it is often impossible to obtain a recording/reproduction characteristic and thermal decay characteristic suited to high-density recording.

Other examples of the material of the perpendicular magnetic recording layer are a CoPt-based alloy, a CoCr-based alloy, a CoPtCr-based alloy, CoPtO, CoPtCrO, CoPtSi, and CoPtCrSi. As the perpendicular magnetic recording layer, it is also possible to use a multilayered film containing Co and an alloy mainly containing at least one element selected from the group consisting of Pt, Pd, Rh, and Ru. It is further possible to use a multilayered film such as CoCr/PtCr, CoB/PdB, or CoO/RhO obtained by adding Cr, B, or O to each layer of the former multilayered film.

The thickness of the perpendicular magnetic recording layer can be 5 to 60 nm, and can also be 10 to 40 nm. A perpendicular magnetic recording layer having a thickness falling within this range is suited to high-density recording. If the thickness of the perpendicular magnetic recording layer is less than 5 nm, the reproduction output becomes too low, so the noise component often becomes higher than the reproduction output. On the other hand, if the thickness of the perpendicular magnetic recording layer exceeds 40 nm, the reproduction output becomes too high and tends to distort the waveform. The coercive force of the perpendicular magnetic recording layer can be 237,000 A/m (3,000 Oe) or more. If the coercive force is less than 237,000 A/m (3,000 Oe), the thermal decay resistance tends to decrease. The perpendicular squareness ratio of the perpendicular magnetic recording layer can be 0.8 or more. If the perpendicular squareness ratio is less than 0.8, the thermal decay resistance often decreases.

A protective layer can be formed on the perpendicular magnetic recording layer.

The protective layer prevents the corrosion of the perpendicular magnetic recording layer, and also prevents damages to the medium surface when a magnetic head comes in contact with the medium. Examples of the material of the protective layer are materials containing C, SiO₂, and ZrO₂. The thickness of the protective layer can be 1 to 10 nm. When the thickness of the protective layer falls within the above range, the distance between a head and the medium can be decreased. This is suitable for high-density recording.

The surface of the perpendicular magnetic recording medium can be coated with, e.g., perfluoropolyether, fluorinated alcohol, or fluorinated carboxylic acid as a lubricant.

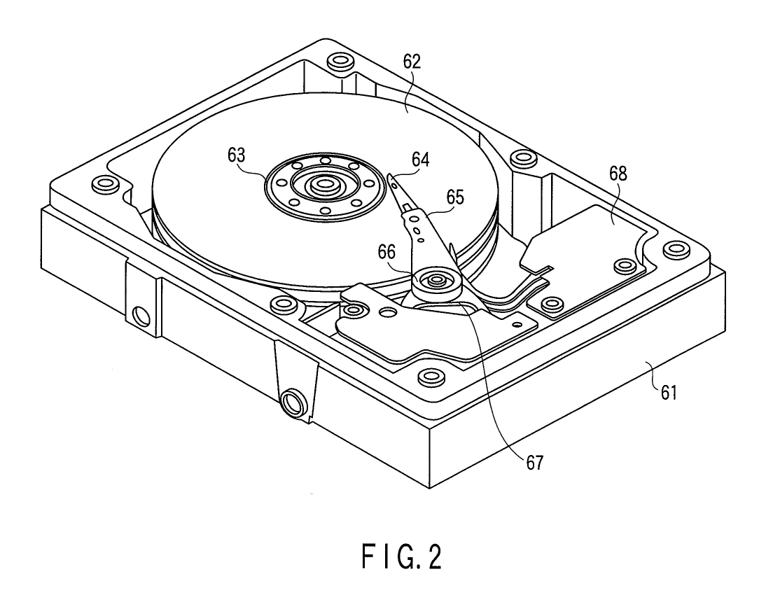

FIG. 2 is a view showing a magnetic recording/reproduction apparatus for recording and reproducing information on and from the magnetic recording medium.

This magnetic recording apparatus includes, in a housing 61, a magnetic recording medium 62, a spindle motor 63 for rotating the magnetic recording medium 62, a head slider 64 including a recording/reproduction head, a head suspension assembly (a suspension 65 and actuator arm 66) for supporting the head slider 64, a voice coil motor 67, and a circuit board.

The magnetic recording medium 62 is attached to and rotated by the spindle motor 63, and various digital data are recorded by the perpendicular magnetic recording method. The magnetic head incorporated into the head slider 64 is a so-called composite head, and includes a write head having a single-pole structure and a read head using a GMR film or TMR film. The suspension 65 is held at one end of the actuator arm 66, and supports the head slider 64 so as to oppose it to the recording surface of the magnetic recording medium 62. The actuator arm 66 is attached to a pivot 68. The voice coil motor 67 is formed as an actuator at the other end of the actuator arm 64. The voice coil motor 67 drives the head suspension assembly to position the magnetic head in an arbitrary radial position of the magnetic recording medium 62. The circuit board includes a head IC, and generates a voice coil motor driving signal, and control signals for controlling read and write by the magnetic head.

An address signal and the like can be reproduced from the processed magnetic recording medium by using this magnetic disk apparatus.

### Examples

The present invention will be explained in more detail below by way of its examples.

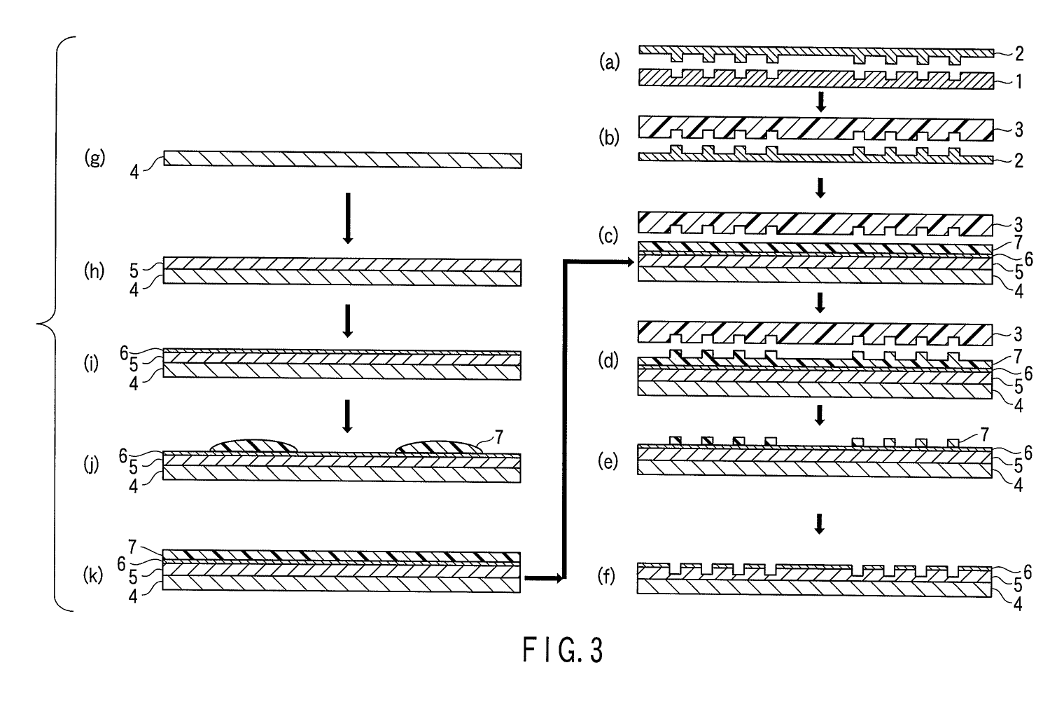

FIG. 3 is a view for explaining a method of the present invention.

A magnetic disk of this example was manufactured in accordance with steps shown in FIG. 3.

In this magnetic disk, the track density is 325,000 tracks per inch, corresponding to a track pitch of 78 nm) in a data zone having a radius of 9 to 22 mm.

To manufacture the magnetic disk having this servo area, imprinting is performed using a stamper having three-dimensional patterns corresponding to magnetic layer patterns on the magnetic disk. Note that the surface of the three-dimensional patterns of the magnetic layer formed by imprinting and subsequent processing may also be planarized by burying a nonmagnetic material in recesses.

A method of manufacturing the magnetic disk according to this example will be explained below.

First, a stamper was manufactured.

An Si wafer having a diameter of 6 inches was prepared as the substrate of a master as a template of the stamper. On the other hand, resist ZEP-520A available from Zeon was diluted to ½ with anisole, and the solution was filtered through a 0.05-μm filter. The Si wafer was spin-coated with the resist solution and prebaked at 200° C. for 3 minutes, thereby forming a resist layer about 50 nm thick.

An electron beam lithography system having a ZrO/W thermal field emission type electron gun emitter was used to directly write desired patterns on the resist on the Si wafer at an acceleration voltage of 50 kV. This lithography was performed using a signal source that synchronously generates signals for forming servo patterns, burst patterns, address patterns, and track patterns, signals to be supplied to a stage driving system (a so-called X-θ stage driving system having a moving mechanism for moving a movable shaft in at least one direction and a rotating mechanism) of the lithography system, and an electron beam deflection control signal. During the lithography, the stage was rotated at a constant linear velocity (CLV) of 500 mm/s, and moved in the radial direction at the same time. Also, concentric track areas were written by deflecting the electron beam for every rotation. Note that the feeding speed was 7.8 nm per rotation, and one track (corresponding to one address bit width) was formed by ten rotations.

The resist was developed by dipping the Si wafer in ZED-N50 (available from Zeon) for 90 seconds. After that, the Si wafer was rinsed as it was dipped in ZMD-B (available from Zeon) for 90 seconds, and dried by air blowing. In this way, a resist master (not shown) was manufactured.

A conductive film of Ni was formed on the resist master by sputtering. More specifically, pure nickel was used as a target. After a chamber was evacuated to 8×10⁻³ Pa, the pressure was adjusted to 1 Pa by supplying gaseous argon, and sputtering was performed in the chamber for 40 seconds by applying a DC power of 400 W, thereby forming a conductive film about 10 nm thick.

The resist master having this conductive film was dipped in a nickel sulfamate plating solution (NS-160 available from Showa Chemical Industry), and Ni electroforming was performed for 90 minutes, thereby forming an electroformed film about 300 μm thick. The electroforming bath conditions were as follows.

Electroforming Bath Conditions

Nickel sulfamate: 600 g/L

Boric acid: 40 g/L

Surfactant (sodium lauryl sulfate): 0.15 g/L

Solution temperature: 55° C.

pH: 4.0

Current density: 20 A/dm²

The electroformed film and conductive film were separated together with the resist residue from the resist master. The resist residue was removed by oxygen plasma ashing. More specifically, plasma ashing was performed for 20 minutes by applying a power of 100 W into a chamber in which the pressure was adjusted to 4 Pa by supplying gaseous oxygen at 100 ml/min. As shown in (a) in FIG. 3, a father stamper 1 including the conductive film and electroformed film as described above was obtained. After that, electroforming was further performed to duplicate a mother stamper 2 as shown in (b) in FIG. 3. An injection molding stamper was obtained by removing unnecessary portions of the mother stamper 2 by a metal blade.

As shown in (c) in FIG. 3, a resin stamper 3 was duplicated from the mother stamper 2 by using an injection molding apparatus manufactured by Toshiba Machine. As the molding material, cyclic olefin polymer Zeonor 1060R available from Zeon was used.

Then, a magnetic disk was manufactured.

As shown in (h) in FIG. 3, a magnetic recording layer 5 including a soft magnetic underlying layer and magnetic layer was formed by sputtering on a disk substrate 4 of donut-like glass 1.8 inches in diameter shown in (g) in FIG. 3.

The magnetic recording layer 5 was a magnetic recording layer for a double-layered medium including a soft magnetic underlying layer and magnetic layer. After a 100-nm-thick soft magnetic underlying layer was formed by using CoZrNb as a target, a 20-nm-thick underlying layer was formed by using an Ru target. In addition, a 20-nm-thick perpendicular magnetic recording layer was formed by performing sputtering by a well-known method in an Ar gas ambient by using CoPtCrSi as a target.

As shown in (i) in FIG. 3, a surface protective layer 6 was formed on the magnetic recording layer 5. After that, as shown in (j) in FIG. 3, the protective layer 6 was spin-coated with a resist 7 made of an ultraviolet-curable resin material at a rotational speed of 10,000 rpm.

The ultraviolet-curable resin material used was made of a monomer, oligomer, and polymerization initiator, and did not contain any solvent.

In this example, isobornyl acrylate (IBOA) was used as the monomer, three types of urethane acrylate represented by formula (2) presented earlier and formulas (4) and (5) below were selectively used as the oligomer, and Darocure 1173 represented by formula (3) below was used as the polymerization initiator. The composition was that IBOA was 85%, the oligomer was 10%, and the polymerization initiator was 5%.

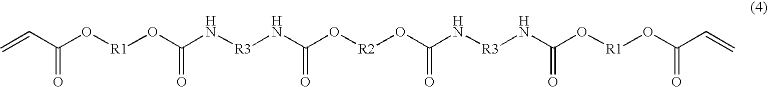

wherein R1 and R3 are as follows.

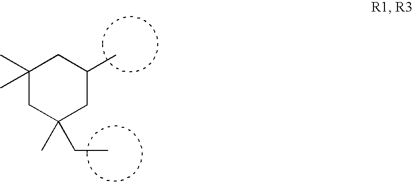

wherein R2 is as follows.

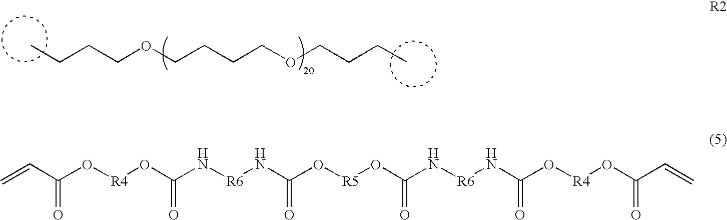

wherein R4 is as follows.

—CH₂—CH₂— R4

wherein R5 is as follows.

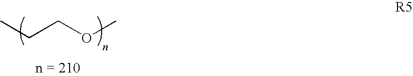

wherein R6 is as follows.

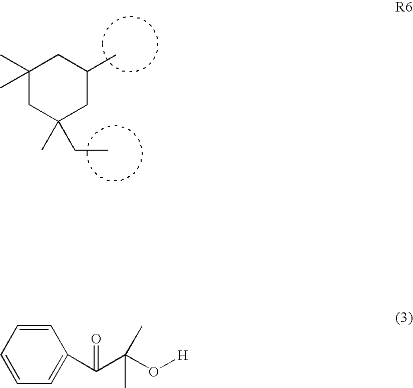

As shown in (c) in FIG. 3, the resin stamper 3 was contacted to the ultraviolet-curable resin resist 7 on the disk substrate surface by vacuum bonding, and the resin was cured by ultraviolet radiation. After that, the resin stamper 3 was separated as shown in (d) in FIG. 3.

In a three-dimensional pattern formation process performed by ultraviolet imprinting, the resist residue remains on the bottoms of pattern recesses.

Then, the resist residue on the bottoms of pattern recesses was removed by RIE using gaseous oxygen. As shown in (e) in FIG. 3, the patterns of the resist 7 were used as masks to etch the magnetic recording layer by Ar ion milling. Subsequently, as shown in (f) in FIG. 3, the resist patterns were removed by oxygen RIE. In addition, a carbon protective layer (not shown) was formed on the entire surface. After that, the manufactured magnetic disk was coated with a lubricant.

In the magnetic disk medium described above, the magnetic recording layer was etched to the bottom in a portion where no resist mask was formed. However, it is also possible to stop Ar ion milling halfway to obtain a medium having projections and recesses. Alternatively, it is possible to obtain a medium by imprinting a stamper onto a resist on a substrate without initially forming any magnetic layer, giving projections and recesses to the substrate shape by etching or the like, and then forming a magnetic film. Furthermore, in any medium including the above-mentioned media, the grooves may also be filled with a certain nonmagnetic material.

A resin stamper was duplicated by the above-mentioned method by using one Ni stamper, and resist mask transfer was performed using an ultraviolet-curable resin. One hundred magnetic disks were duplicated for each ultraviolet-curable resin.

First, the relationship between the constituting ratio of the monomer and the viscosity of the ultraviolet-curable resin was that the viscosity was 20 CP at 60%, 15 CP at 70%, 12 CP at 75%, 10 CP at 80%, 8 CP at 85%, 6 CP at 90%, and 4 CP at 95%.

The molecular weights of the oligomer were 2,500 (TS2P-01B), 10,000 (TS2P-01A), and 10,000 (TS2P-01C). When using TS2P-01B, the resin stamper was not well separated from the magnetic disk medium, and the ultraviolet-curable resin resist layer was destroyed in 55 disks out of 100.

The ultraviolet-curable resin containing 60% of the monomer adhered to the resin stamper and could not be separated for 73 disks out of 100.

The ultraviolet-curable resin containing 70% of the monomer was sticking to the resin stamper after being separated for 61 disks out of 100.

The ultraviolet-curable resin containing 75% of the monomer was sticking to the resin stamper after being separated for 5 disks out of 100.

The ultraviolet-curable resin containing 80% or more of the monomer could be well separated for 100 disks, so it was possible to manufacture magnetic disk media.

One thousand magnetic disks were manufactured using this ultraviolet-curable resin. A magnetic recording apparatus was manufactured using the manufactured magnetic disk for every appropriate number of times of imprinting, and address signals were detected. Consequently, predetermined address signals were obtained from the inner periphery to the outer periphery of any magnetic disk including the 1,000th magnetic disk.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium manufacturing method comprising:
contacting a surface of a magnetic recording layer of a magnetic recording medium comprising a data area and a servo area to a three-dimensional pattern surface of a resin stamper in a vacuum, wherein the surface of the magnetic recording layer comprises an uncured ultraviolet-curable resin layer comprising a monomer of the formula (1); 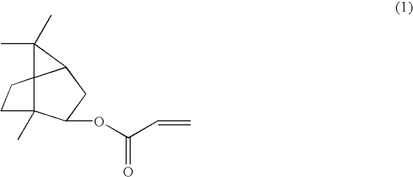
curing the uncured ultraviolet-curable resin layer by irradiating ultraviolet light;
removing the resin stamper, thereby forming an ultraviolet-curable resin layer comprising a three-dimensional pattern on a surface of the magnetic recording medium; and
forming the three-dimensional pattern on the first surface of the magnetic recording layer by performing dry etching with the ultraviolet-curable resin layer as a mask.

2. The method of claim 1, further comprising:
forming the uncured ultraviolet-curable resin layer comprising an ultraviolet-curable resin material comprising 80 to 90 wt % of the monomer, and an oligomer comprising a molecular weight larger than 2,500.

3. The method of claim 1, further comprising:
forming the uncured ultraviolet-curable resin layer comprising an ultraviolet-curable resin material further comprising an oligomer of the formula (2), 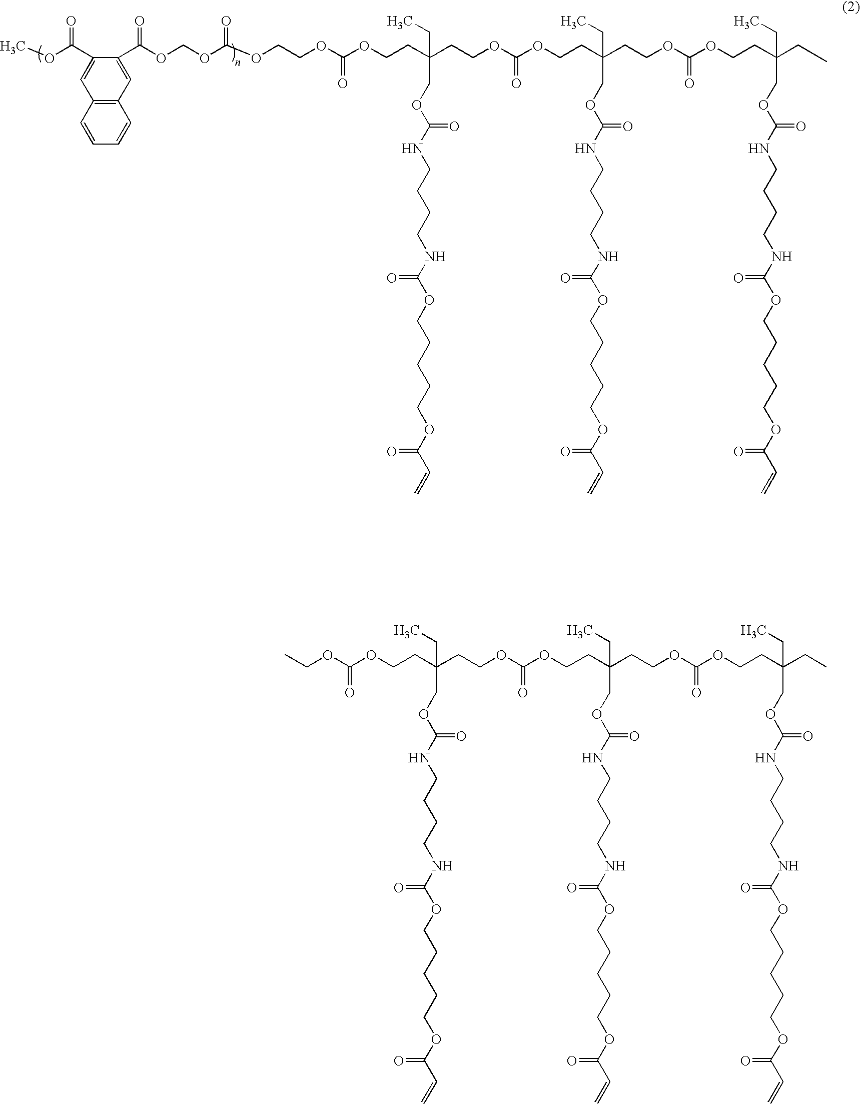
wherein n=25.

4. The method of claim 1, wherein a viscosity of the ultraviolet-curable resin before curing is equal to or lower than 10 centipoise at 25° C.

5. An ultraviolet-curable resin material comprising a monomer of formula (1), and used to form an uncured ultraviolet-curable resin layer comprising a three-dimensional pattern of a resin stamper on a surface of a magnetic recording layer of a magnetic recording medium comprising a data area and a servo area.

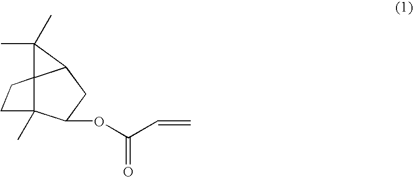

6. The material of claim 5, wherein the uncured ultraviolet-curable resin layer comprises an ultraviolet-curable resin material comprising 80 to 90 wt % of the monomer, and an oligomer comprising a molecular weight larger than 2,500.

7. The material of claim 5, wherein the uncured ultraviolet-curable resin layer comprises an ultraviolet-curable resin material further comprising an oligomer comprising a formula (2), 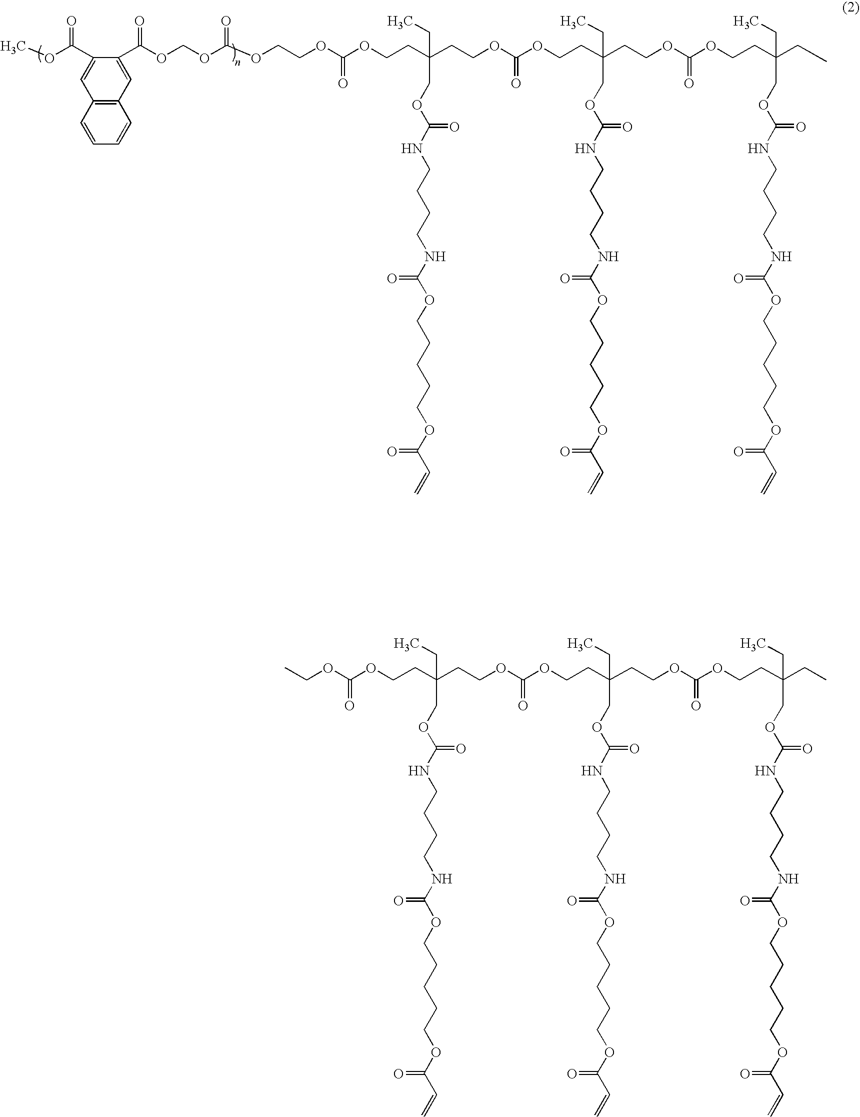
wherein n=25.

8. The material of claim 5, wherein a viscosity before curing is equal to or lower than 10 centipoise at 25° C.

9. A magnetic recording medium comprising:
a magnetic recording layer comprising a three-dimensional surface formed by contacting a resin stamper under a vacuum to form an uncured ultraviolet-curable resin layer comprising a monomer of the formula (1); 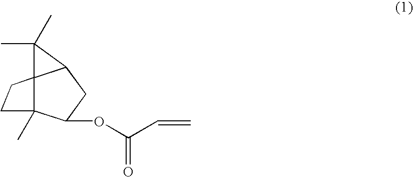
curing the uncured ultraviolet-curable resin layer by irradiating ultraviolet light; and
removing the resin stamper and dry etching with the ultraviolet-curable resin layer as a mask.

10. The magnetic recording medium of claim 9, wherein the uncured ultraviolet-curable resin layer comprises an ultraviolet-curable resin material comprising 80 to 90 wt % of the monomer, and an oligomer comprising a molecular weight larger than 2,500.

11. The magnetic recording medium of claim 9, wherein the uncured ultraviolet-curable resin layer comprises an ultraviolet-curable resin material further comprising an oligomer of the formula (2), 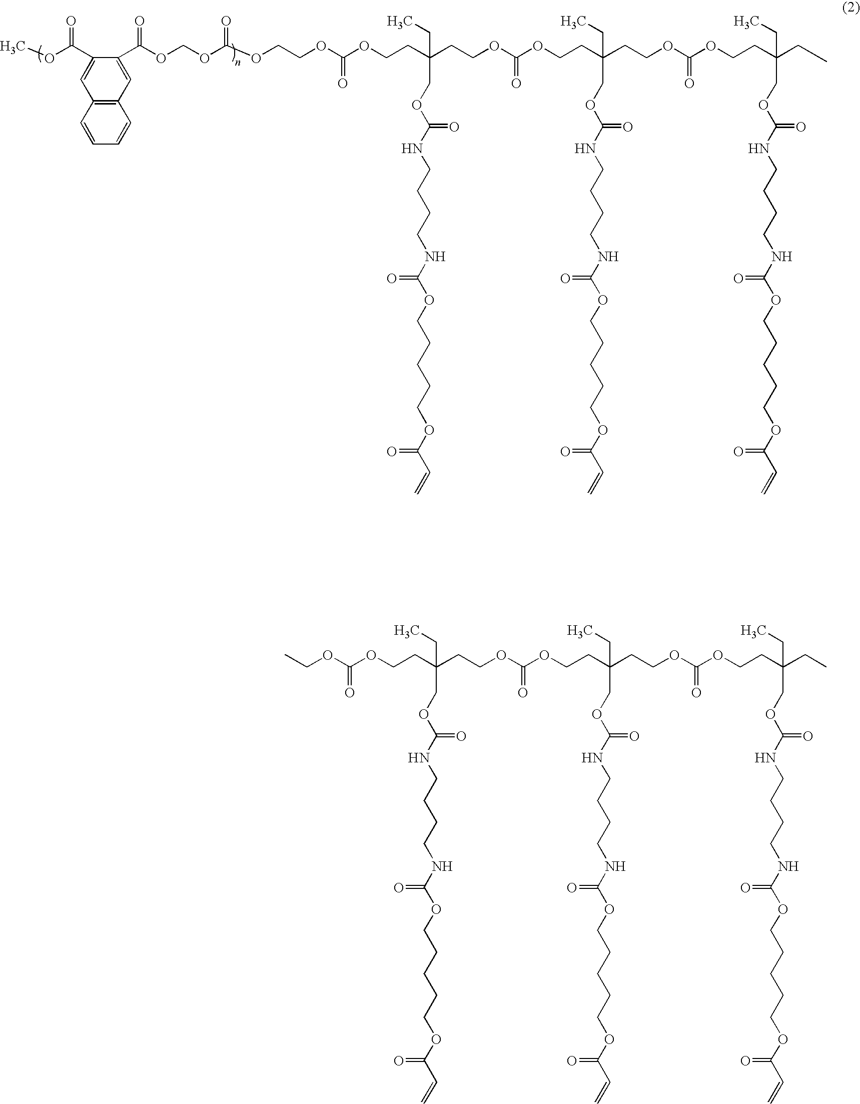
wherein n=25.
